(19) United States
(12) Patent Application Publication
(10) Pub. No.: US 2024/0419512 A1
(43) Pub. Date: Dec. 19, 2024

(54) APPARATUS, MANAGEMENT SERVER, DISTRIBUTED PROCESSING SYSTEM, AND METHOD

(71) Applicant: AI inside Inc., Tokyo (JP)

(72) Inventor: Weiming HU, Shibuya-ku (JP)

(73) Assignee: AI inside Inc., Tokyo (JP)

(21) Appl. No.: 18/817,406

(22) Filed: Aug. 28, 2024

Related U.S. Application Data
(63) Continuation of application No. PCT/JP2023/000130, filed on Jan. 6, 2023.

(30) Foreign Application Priority Data
Mar. 25, 2022 (JP) 2022-049403

(51) Int. Cl. G06F 9/50; G06F 9/48

(52) U.S. Cl. CPC G06F 9/5083; G06F 9/4881

(57) ABSTRACT

A management server includes processing circuitry configured to accept a task that is a request for calculation by a distributed processing system from a terminal device, decompose the task into a plurality of jobs, determine, from calculation resources available for calculation servers obtained in advance from the calculation servers, respectively, a schedule of the jobs to be allocated to the calculation servers, transmit, based on the schedule, the jobs to be allocated to the calculation servers, respectively, accept calculation results of the jobs from the calculation servers, respectively, generate a calculation result of the task based on the accepted calculation results of the jobs, and transmit the calculation result of the task to the terminal device.

### CROSS-REFERENCE TO RELATED APPLICATION

This application is a continuation of International Application No. PCT/JP2023/000130, filed Jan. 6, 2023, which claims priority to Japanese Patent Application No. 2022-049403, filed Mar. 25, 2022, the entire contents of each are incorporated herein by reference.

### FIELD

The present disclosure relates to a program, a server, a system, and a method.

### BACKGROUND

For example, for the purpose of performing large-scale numerical calculations, a distributed processing system is known that divides numerical calculations, allocates the divided numerical calculations to a plurality of nodes, respectively, and collectively outputs the calculation results from the nodes. In such a distributed processing system, one process is performed in a distributed manner in order to improve the processing speed and reduce the load on the nodes.

As distributed processing methods by conventional distributed processing systems, there are a method of performing processing by mounting a large number of processors on one computer, a method of distributing large-scale data processing to a plurality of servers and sharing processing results on a network, and the like. According to the latter distributed processing method, the processing speed can be improved compared to processing by one server, and the operating ratio of calculation processing can be guaranteed.

In a conventional distributed processing system, for the purpose of effectively using each calculation resource and to speed up the job processing more than before, a plurality of nodes connected to a network are provided, the amount of calculation resources consisting of one or more of the current load status, the past records, the node status/specification, and the distance on the network is monitored for each of the plurality of nodes, and a node to which a job is to be requested is selected based on the monitored information.

However, actually preparing a plurality of servers is costly. Therefore, even if a large number of calculations is desired, it is difficult to prepare a server group required for distributed processing. Additionally, even if a server group required for distributed processing can be prepared, it is necessary to quickly prepare a calculation resource to a user.

Therefore, an object of the present disclosure, which has been made to solve the above-described problems, is to realize a virtual data center (DC), and to provide a program, a server, a system, and a method capable of providing a user with distributed processing that effectively utilizes calculation resources quickly and at low cost.

### BRIEF DESCRIPTION OF DRAWINGS

FIG. 1 is a diagram illustrating the overview of a system according to an embodiment.

FIG. 2 is a block diagram illustrating the hardware configuration of the system according to the embodiment.

FIG. 3 is a diagram illustrating the functional configuration of a management server according to the embodiment.

FIG. 4 is a diagram illustrating the functional configuration of a calculation server according to the embodiment.

FIG. 5 is a diagram illustrating the data structure of a node management DB stored in the management server according to the embodiment.

FIG. 6 is a diagram illustrating the data structure of a task management DB stored in the management server according to the embodiment.

FIG. 7 is a diagram illustrating the data structure of a job management DB stored in the management server according to the embodiment.

FIG. 8 is a diagram illustrating an example of an allocation table stored in the management server according to the embodiment.

FIG. 9 is a flowchart for describing an example of the operation of the management server according to the embodiment.

FIG. 10 is a flowchart for describing another example of the operation of the management server according to the embodiment.

FIG. 11 is a flowchart for describing still another example of the operation of the management server according to the embodiment.

FIG. 12 is a flowchart for describing yet another example of the operation of the management server according to the embodiment.

FIG. 13 is a sequence diagram for describing an example of the operation of the system according to the embodiment.

FIG. 14 is a diagram illustrating an example of a screen displayed on a terminal device in the system according to the embodiment.

FIG. 15 is a diagram illustrating another example of the screen displayed on the terminal device in the system according to the embodiment.

FIG. 16 is a diagram illustrating still another example of the screen displayed on the terminal device in the system according to the embodiment.

### DETAILED DESCRIPTION

In general, according to one embodiment, there is provided an apparatus in a distributed processing system that includes a plurality of nodes, and the management server connected to each of these nodes via a network, each of the nodes participating in the distributed processing system via the network according to its own setting. An apparatus comprises processing circuitry configured to accept, by the entire distributed processing system, a task that is a request for calculation by the distributed processing system from a client outside the distributed processing system, decompose the task into a plurality of jobs, determine, from calculation resources available for the nodes obtained in advance from the nodes, respectively, a schedule of the jobs to be allocated to the nodes, transmit, based on the schedule, the jobs allocated to the nodes, respectively, accept calculation results of the jobs from the nodes, respectively, generate a calculation result of the task based on the accepted calculation results of the jobs, and transmit the calculation result of the task to the client.

Hereinafter, an embodiment of the present disclosure will be described with reference to the drawings. In all figures describing the embodiment, common components are denoted by the same numerals, and repeated description will be omitted. Note that the following embodiment does not unreasonably limit the content of the present disclosure written in the claim. Additionally, not all the components illustrated in the embodiment are necessarily essential components of the present disclosure. Additionally, each figure is a schematic diagram, and is not necessarily strictly illustrated.

Additionally, in the following description, “a processor” is one or more processors. Although at least one processor is typically a microprocessor such as a CPU (Central Processing Unit), other types of processors such as a GPU (Graphics Processing Unit) may be used. At least one processor may be single-core or multi-core.

Additionally, at least one processor may be a processor in a broad sense such as a hardware circuit (for example, an FPGA (Field-Programmable Gate Array) or an ASIC (Application Specific Integrated Circuit)) that performs a part or all of processing.

Additionally, in the following description, although an expression such as “x×x table” may be used to describe information that can provide an output to an input, this information may be data having any structure, and may be a learning model such as a neural network that generates an output to an input. Accordingly, “x×x table” can be called “xxx information.”

Additionally, in following the description, the configuration of each table is an example, and one table may be divided into two or more tables, or all or a part of two or more tables may be one table.

Additionally, in the following description, although processing may be described by using a “program” as a subject, the subject of the processing may be a processor (or a device such as a controller including the processor), since the program is executed by the processor to perform defined processing while appropriately using, for example, a storage and/or an interface unit.

A program may be installed in an apparatus such as a calculator, or may be in, for example, a program distribution server or a (for example, non-transitory) recording medium that can be read by a calculator. Additionally, in the following description, two or more programs may be realized as one program, or one program may be realized as two or more programs.

Additionally, in the following description, although an identification number is used as identification information on various targets, the identification information on types other than an identification number (for example, identifier including an alphabetical character and a code) may be adopted.

Additionally, in the following description, when describing elements of the same type without distinguishing them, reference numerals (or common numerals among reference numerals) are used, and when distinguishing and describing elements of the same type, identification numbers (or reference numerals) of the elements may be used.

Additionally, in the following description, a control line and an information line indicate those considered to be required for description, and do not necessarily indicate all control lines and information lines required for products. All configurations may be connected to each other.

### Embodiment

### Summary of Embodiment

In a distributed processing system according to an embodiment, in response to a calculation processing request from a terminal device that is a client, a management server divides this calculation processing request into a plurality of parts, allocates them to nodes, summarizes calculation results from the nodes, and send them back to the client. The management server and the plurality of nodes constitute the distributed processing system (virtual data center) as a whole. Although the distributed processing system of the present embodiment is applicable to entire calculation processing, the distributed processing system will be described below as mainly performing large-scale numerical calculations. Large-scale numerical calculations described herein may include an inference operation based on artificial intelligence (AI), image processing/image analysis operations, a statistical processing operation based on so-called big data, and the like.

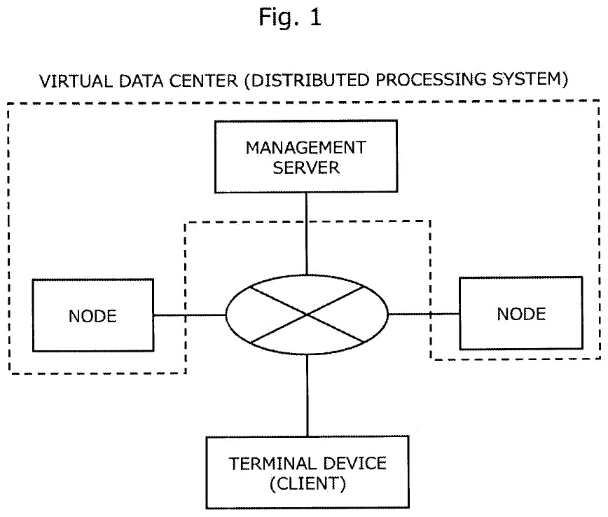

Referring to FIG. 1, the overview of the distributed processing system, which is the embodiment, will be described.

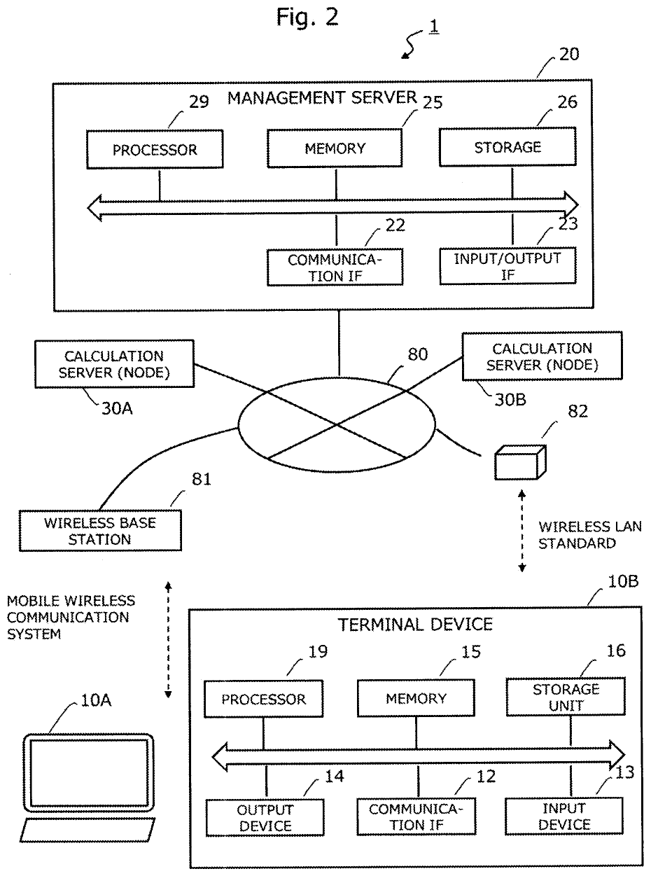

The distributed processing system 1 to the embodiment includes a management server 2 and a plurality of nodes 3, and the management server 2 and nodes 3 are configured to be able to communicate with each other via a network 5. Although the distributed processing system 1 includes two nodes 3 in FIG. 1 and FIG. 2, which will be described later, it is sufficient that the distributed processing system 1 includes a plurality of nodes 3, and there is no limitation to the number of nodes. Additionally, in FIG. 1 and FIG. 2, although the nodes 3 are not directly connected to each other (that is, without the network 5), in the present embodiment, there is no intention of excluding an aspect in which the plurality of nodes 3 are directly interconnected.

In the following description, the node 3 should be recognized in a broad sense. That is, the nodes 3 may be in units of processors, may be in units of information processing apparatuses such as computers, or may be, for example, a server group constituted by a plurality of information processing apparatuses. There is also no particular limitation to the positional relationship between the nodes 3 and the management server 2, and for example, when the nodes 3 are servers, the installation mode may be any of on-premise, edge, and cloud. However, in the present embodiment, the nodes 3 are considered in units of processors. That is, when there are a plurality of processors in one information processing apparatus (server), it is considered that this server consists of a plurality of nodes.

In a conventional distributed processing system, the connection mode between the nodes 3 can be considered variously. Although each of the nodes 3 is connected one-dimensionally in the distributed processing system 1 illustrated in FIG. 1 and FIG. 2, when the nodes 3 can independently communicate with each other, the nodes 3 may be connected two-dimensionally, or three or more dimensional connection modes can also be considered. When the connection mode of the nodes 3 is two or more dimensional, the plurality of nodes 3 can also be collectively regarded as a node group. That is, an aspect can also be considered in which the management server 2 allocates single numerical calculation to the node group, and each of the nodes that belong to the node group cooperatively performs this numerical computation. However, in the present embodiment, since the connection mode of the nodes 3 is one-dimensional as described above, allocation of numerical calculation is performed on single node 3. Such a connection mode between the nodes 3 is considered at the time of creation of an allocation table for the nodes 3, which will be described later. Additionally, the connection mode between the nodes 3 also affects the transmission speed and the network distance between the management server 2 and the nodes 3.

As one of the characteristics of the distributed processing system 1 of the present embodiment, each of the nodes 3 performs participation in the distributed processing system 1 according to its own setting. This is because the premise of the distributed processing system 1 of the present embodiment includes a case where the nodes 3 are not facilities dedicated for the distributed processing system 1. That is, in a state where the nodes 3 are not participating in the distributed processing system 1, the nodes 3 can perform information processing imposed by their owners, and in a state where the nodes 3 are participating in the distributed processing system 1, the nodes 3 perform numerical calculations allocated from the management server 2 without performing information processing that are imposed by the owners. Accordingly, by causing the nodes 3 to participate in the distributed processing system 1 during free time when the nodes 3 are not used by the owners, the calculation resources that are not used by the owners of the nodes 3 can be provided for the distributed processing system 1. Therefore, according to the distributed processing system 1 of the present embodiment, calculation resources can be secured quickly and at low cost.

The participation of the nodes 3 in the distributed processing system 1 is basically active. That is, the nodes 3 participate in the distributed processing system 1 according to the setting of the nodes 3 themselves. This is different from a well-known distributed processing system in which, when a calculation resource is available even when an application is always operated in an information processing apparatus to identify the calculation resource of the information processing apparatus, and various kinds of information processing is performed by the owner of the information processing apparatus, information processing from the management server is performed in parallel to the various kinds of information processing by the owner.

Referring again to FIG. 1, a terminal device 4, which is a client, requests numerical calculation processing to the distributed processing system 1 via the network 5. In the following description, this numerical calculation processing is referred to as a task. The task may be received by any of the management server 2 or the nodes 3 that constitute the distributed processing system 1. When one of the node 3 receives the task, the receiving node 3 transmits the task to the management server 2.

The management 2 identifies the available server calculation resource of each of the nodes 3, the communication speed between the management server 2 and each of the nodes 3, and the network distance between the management server 2 and each of the nodes 3. Preferably, each of the nodes 3 periodically notifies the available calculation resource to the management server 2. Additionally, the communication speed between the management server 2 and each of the nodes 3, and the network distance between the management server 2 and each of the nodes 3 are (preferably periodically) measured and identified by the management server 2 itself.

The management server 2 analyzes the received task, and decomposes this task into a plurality of parts. In the following description, a decomposed task is referred to as a job. Then, the management server 2 creates a schedule (allocation table) of the job that is to be allocated to each of the nodes 3 in consideration of the available calculation resource of each of the nodes 3, and transmits, to each of the nodes 3, the job to be allocated to the node 3, based on this schedule.

Preferably, the management server 2 calculates the number of man-hours until the management server 2 accepts the calculation results of jobs in all the nodes 3, and when the man-hours exceeds a predetermined value, the management server 2 generates a schedule that allocates the jobs to the nodes 3 for which the communication speed between the nodes 3 and the management server 2 is less than a predefined threshold value. Additionally, the management server 2 determines the nodes 3 to which the jobs are to be allocated in the order of the shortest network distance between each of the nodes 3 and management server 2, or in the order of the lowest routing cost between each of the nodes 3 and management server 2, and determines a schedule for allocating the jobs to the determined nodes 3.

Each of the nodes 3 to which a job is allocated performs a numerical calculation for this job, and transmits the calculation result to the management server 2. When the management server 2 receives the calculation results from all the nodes 3 to which the jobs are allocated, the management server 2 summarizes the calculation results into the calculation result of the task, and returns the calculation result of the task to the terminal device 4 that has requested the task.

As already described, the nodes 3 participates in the distributed processing system 1 according to their own setting. Although the setting can be changed at arbitrary timing, when a job has been allocated to one of the nodes 3 from the management server 2, and the node 3 stops participating in the distributed processing system 1 while performing a numerical calculation for the job, there is a possibility that the management server 2 cannot receive the result of the numerical calculation for the job. Therefore, even when the management server 2 receives the setting indicating that the node 3 to which the job has been currently allocated does not participate in the distributed processing system 1, the management server 2 informs that the node 3 cannot leave (stop participating in) the distributed processing system 1 until the result of the numerical calculation is received, and causes the node 3 to continue participating in the distributed processing system 1. Then, the management server 2 performs setting that, when the management server 2 receives the calculation result of the job from the node 3, the management server 2 accepts the setting from the node 3 and the node 3 leaves the distributed processing system 1.

In this manner, in the distributed processing system 1 of the present embodiment, it is preferable for the nodes 3 to secure a certain amount of flexibility to leave from the distributed processing system 1. Therefore, the management server 2 divides a task into jobs as small as possible (that is, the number of calculation steps is small), and secures as many timings as possible at which the nodes 3 can leave from the distributed processing system 1. As one of the techniques for dividing a task into a small jobs, a technique can be listed that makes the number of calculation steps required for each of the jobs constant.

### <Basic Configuration of System 1>

Referring to FIG. 2, the basic configuration of the distributed processing system 1, which is the embodiment, will be described.

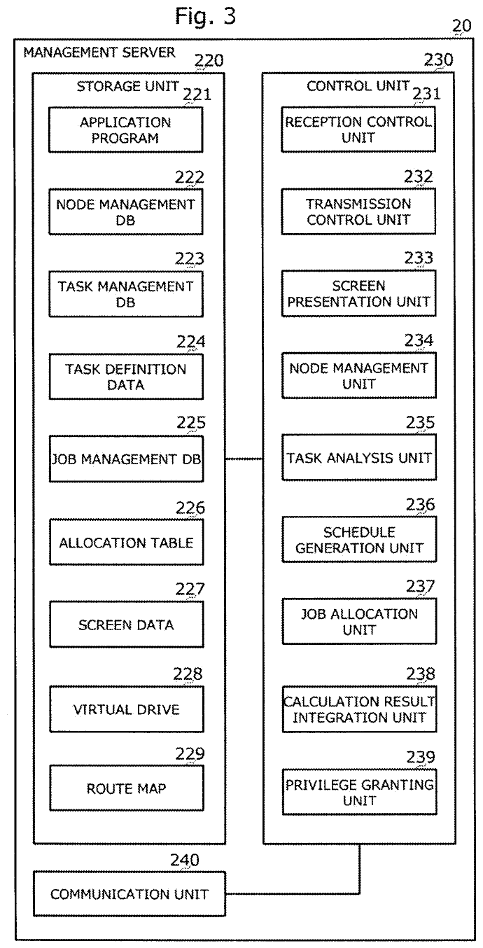

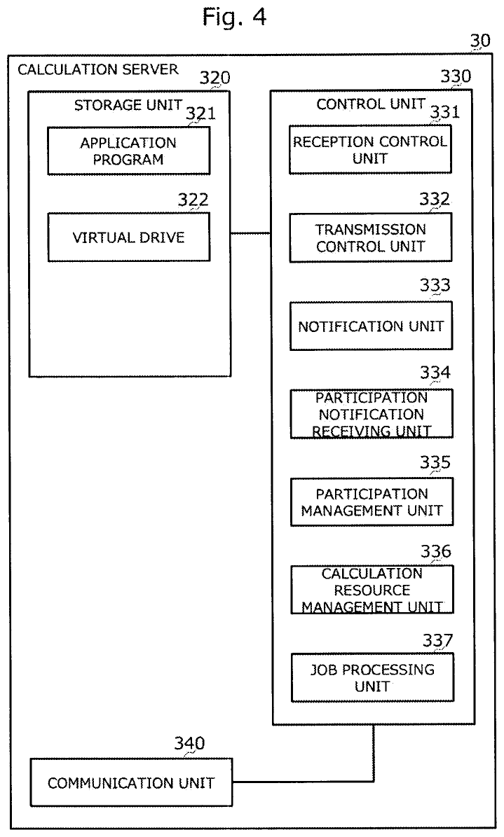

FIG. 2 is a diagram illustrating the configuration of the entire distributed processing system 1 of the embodiment. As illustrated in FIG. 2, the distributed processing system 1 of the present embodiment includes a plurality of terminal devices 10 (FIG. 2 illustrates a terminal device 10A and a terminal device 10B. Hereinafter, they may be collectively referred to as “the terminal device 10”) connected via a network 80, a management server 20, and a calculation server 30 (FIG. 2 illustrates a calculation server 30A and a calculation server 30B. Hereinafter, they may be collectively referred to as “the calculation server 30”). FIG. 3 illustrates the functional configuration of the management server 20, and FIG. 4 illustrates the functional configuration of the calculation server 30. These management server 20, calculation server 30, and terminal device 10 are constituted by information processing apparatuses.

An information processing apparatus is constituted by a computer including an arithmetic unit and a storage device. The basic hardware configuration of the computer, and the basic function configuration of the computer realized by the hardware configuration will be described later. Note that, for each of the management server 20, the calculation server 30, and the terminal device 10, a description that overlaps with the basic hardware configuration of the computer and the basic function configuration of the computer, which will be described later, will not be repeated.

The management server 20 is an information processing apparatus that organizes the distributed processing system 1 of the present embodiment, and is operated by an operator of the distributed processing system 1. The calculation server 30 is an information processing apparatus that actually performs calculation processing (executes jobs) in the distributed processing system 1 of the present embodiment. As a characteristic of the distributed processing system 1 of the present embodiment, the operator of the calculation server 30 does not necessarily need to be the same person as the operator of the management server 20. That is, the operator (owner) other than the operator of the management server 20 may operate the calculation server 30. In addition, in a state where the calculation server 30 has not participated in the distributed processing system 1, the calculation server 30 exclusively performs various kinds of information processing by the owner. On the other hand, in a state where the calculation server 30 has participated in the distributed processing system 1, the calculation server 30 functions as an exclusive server for performing calculation processing of a job allocated from the management server 20.

The terminal device 10 is a device operated by each user. Here, a user is a person who uses the terminal device 10 to request execution of a job, and a user of the distributed processing system 1. A user is not particularly limited, and includes a university researcher, a corporate researcher, and the like who wish to perform large-scale numerical calculations by the distributed processing system 1. The terminal device 10 may be, for example, a mobile terminal such as a tablet suitable for a mobile communication system, and a smart phone, or may be a stationary PC (Personal Computer), a laptop PC, or the like.

The terminal device 10 is communicatively connected to the management server 20 and the calculation server 30 via the network 80. The terminal device 10 communicates with a wireless base station 81 compliant with communication standards such as 4G, 5G, LTE (Long Term Evolution), and a communication equipment such as a wireless LAN router 82 compliant with wireless LAN (Local Area Network) standard such as IEEE (Institute of Electrical and Electronics Engineers) 802.11 to be connected to the network 80. When the terminal device 10 is wirelessly connected to the wireless LAN router 82 and the like, for example, Z-Wave (registered trademark), ZigBee (registered trademark), Bluetooth (registered trademark), and the like are included as the communications protocols. When connecting by wire, direct connection with a USB (Universal Serial Bus) cable or the like is also included.

As illustrated in FIG. 2 as the terminal device 10B, the terminal device 10 includes a communication IF (interface) 12, an input device 13, an output device 14, a memory 15, a storage unit 16, and a processor 19.

The communication IF 12 is an interface for inputting and outputting signals, so that the terminal device 10 communicates with an external device such as the management server 20. The input device 13 is an input device (for example, a pointing device, such as a keyboard, a touch panel, a touchpad, and a mouse) for receiving input operations from a user. The output device 14 is an output device (a display, a loudspeaker, and the like) for presenting information to the user. The memory 15 is for temporarily storing programs, data to be processed by the program, and the like, and is, for example, a volatile memory such as a DRAM (Dynamic Random Access Memory). The storage unit 16 is a storage device for saving data, and is, for example, a flash memory or an HDD (Hard Disc Drive). The processor 19 is a hardware for performing instruction sets written in the programs, and is constituted by an arithmetic unit, a register, a peripheral circuit, and the like.

The management server 20 is an information processing apparatus that performs operation/management of the distributed processing system 1, and the calculation server 30 is an information processing apparatus that performs jobs in the distributed processing system 1. Although FIG. 2 illustrates only the hardware configuration of the management server 20, the hardware configuration of the calculation server 30 is the same as that of the management server 20, and thus is not illustrated. The management server 20 includes a communication IF 22, an input/output IF 23, a memory 25, a storage 26, and a processor 29.

The communication IF 22 is an interface for inputting and SO outputting signals, that the management server 20 communicates with an external device. The input/output IF 23 functions as an interface with an input device, which is not illustrated, for receiving input operations from a user, and with an output device, which is not illustrated, for presenting information to the user. The memory 25 is for temporarily storing programs, data to be processed by the program, and the like, and is, for example, a volatile memory such as a DRAM (Dynamic Random Access Memory). The storage 26 is a storage device for saving data, and is, for example, a flash memory, or an HDD (Hard Disc Drive). The processor 29 is a hardware for executing instruction sets written in the programs, and is constituted by an arithmetic unit, a register, a peripheral circuit, and the like.

### <Functional Configuration of Management Server 20>

FIG. 3 illustrates the functional configuration realized by the hardware configuration of the management server 20. The management server 20 includes a storage unit 220, a control unit 230, and a communication unit 240. The communication unit 240 is constituted by the communication IF 22, the storage unit 220 is constituted by the storage 26 of the management server 20, and the control unit 230 is mainly constituted by the processor 29 of the management server 20.

The communication unit 240 performs communication with the terminal device 10, the calculation server 30, and the like via the network 80.

### <Configuration of Storage Unit 220 of Management Server 20>

The storage unit 220 of the management server 20 includes a node management DB (DataBase) 222, a task management DB 223, a task definition data 224, a job management DB 225, an allocation table 226, a screen data 227, a virtual drive 228, and a route map 229.

Among these node management DB 222 and the like, those except for the task definition data 224, the allocation table 226, the screen data 227, and the virtual drive 228 are databases. A database described herein refers to a relational database, and is for mutually associating and managing data sets called tables in tabular forms that are structurally defined by rows and columns. In a database, a table is called a table, a column of the table is called a column, and a row of the table is called a record. In a relational database, the relationships between tables can be set and tables can be associated with each other.

Usually, although a column used as a primary key for uniquely specifying a record is set to each table, the setting of the primary key to the column is not essential. The control unit 230 can cause the processor 29 to perform addition of a record to, deletion of a record from, and updating of a record in a specific table stored in the storage unit 220, according to various kinds of programs.

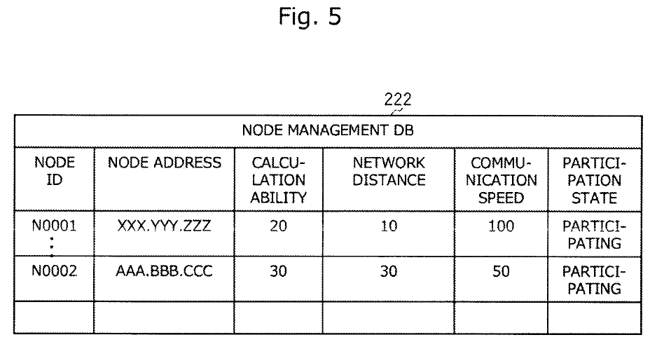

FIG. 5 is a diagram illustrating the data structure of the node management DB 222. The node management DB 222 is a database for the management server 20 to manage the nodes (the calculation server 30) constituting the distributed processing system 1.

The node management DB 222 is a table that uses a node ID as the primary key for specifying the calculation server 30 (node) constituting the distributed processing system 1, and includes the columns of node address, calculation ability, network distance, communication speed, and participation state.

“Node ID” is the information for specifying the calculation server 30. “Node address” is an address for identifying and specifying the calculation server 30 in the network 80, and as an example, IP addresses are input as node addresses in the example illustrated in FIG. 5. Although the IP addresses based on IPv4 are input in the example illustrated in FIG. 5, the IP addresses may be IP addresses based on IPv6, or information other than IP addresses that identifies and specifies the calculation server 30 in the network 80.

“Calculation ability” is a value indicating the calculation resource of the calculation server 30 specified by a node ID. Although so-called dimensionless values are input in the example illustrated in FIG. 5, the clock frequency of a processor included in the calculation server 30, the number of operations per clock, a FLOPS (Floating point number Operations Per Second) that is obtained by multiplying the clock frequency with the number of operations per clock, and the like can be preferably used as the value indicating the calculation ability. In the example indicated in FIG. 5, relative values for a specific processor are input as the values used as the calculation ability.

“Network distance” is a value indicating the network distance between the calculation server 30 specified by a node ID and the management server 20. Although so-called dimensionless values are input in the example illustrated in FIG. 5, as the value indicating the network distance, the management server 20 may issue a ping command toward the calculation server 30, or the calculation server 30 may issue a ping command toward the management server 20, and the response time (for example, RTT: Round Trip Time) may be used as the network distance. However, since the RTT may include various kinds of delay (latency), it should be noted that, when the RTT is used as the network distance, the RTT is not a distance in a strict meaning, but a value as a tentative guideline. Additionally, although the communication speed may be generally used as the network distance, since the communication speed is used for management of the distributed processing system 1 separately from the network distance in the present embodiment, the network distance and the communication speed are handled as separate parameters.

“Communication speed” is a value indicating the communication speed between the calculation server 30 specified by a node ID and the management server 20. Although so-called dimensionless values are input in the example indicated in FIG. 5, the communication speed in units of bps (bit per second) is generally used. As an example, the communication speed can be obtained from the amount of communication and the time for uploading specific data from the calculation server 30 to the management server 20, and the amount of communication and the time for downloading specific data from the management server 20 to the calculation server 30. However, since uploading/downloading of data are performed in the application layer in the OSI reference model, it should be noted that, since the communication speed based on uploading/downloading of data is the communication speed in the application layer, and is, on the other hand, the network distance based on the response time of the ping command (in many cases, the ping command is communication in the transport layer) is the communication speed in the transport layer, these two may have different values. “Participation state” is a value related to the state of whether or not the calculation server 30 specified by a node ID is currently participating in the distributed processing system 1.

In the node management DB 222, a node ID is generated by a node management unit 234, and the other columns are stored in the node management DB 222 by the node management unit 234 based on notifications from each calculation server 30.

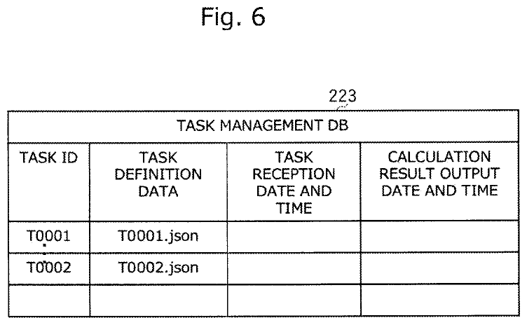

FIG. 6 is a diagram illustrating the data structure of the task management DB 223. Task management DB 223 is a database for managing tasks of performing calculation processing by the distributed processing system 1.

Task management DB 223 is a table that uses a task ID as a primary key for specifying a task of performing calculation processing in the distributed processing system 1, and includes the columns of task definition data, task reception date and time, and a calculation result output date and time.

“Task ID” is the information for specifying a task. “Task definition data” is data to be referred to when performing calculation processing of a task in the distributed processing system 1. The details will be described later. “Task reception date and time” is a value related to the date and time at which the management server 20 has received a task. “Calculation result output date and time” is a value related to the date and time at which, as a result of performing calculation processing related to a task, the calculation result is transmitted to the terminal device 10 that is the client that has transmitted the task.

In the task management DB 223, a task ID is generated by a task analysis unit 235, a task definition data and a task reception date and time are stored in the task management DB 223 by the task analysis unit 235 based on inputs from the terminal device 10, and a calculation result output date and time is stored in the task management DB 223 by a calculation result integration unit 238.

The task definition data 224 is data that defines the specifications on tasks to be processed in the distributed processing system 1. The task definition data 224 includes at least the data on the following items.
Processing models required when processing tasks. As an example, when a task is calculation processing related to machine learning, the processing model is a neural network for performing an inference operation, or the like.
Data at the time of processing tasks. As an example, when a task is calculation processing related to machine learning, data is training data, variables of a neural network, and the like.

As illustrated in FIG. 6, the task definition data 224 is written in the JSON (JavaScript Object Notation) format (JavaScript is a registered trademark), which is an example of data description languages, but the data description format is not limited to this.

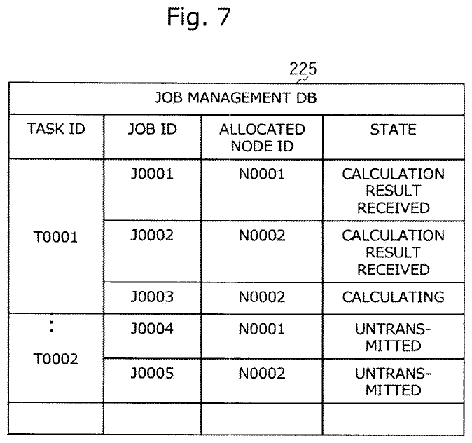

FIG. 7 is a diagram illustrating the data structure of the job management DB 225. The job management DB 225 is a database for managing jobs to be allocated (assigned) to the calculation server 30 by the management server 20.

The job management DB 225 is a table that uses a task ID, which is the information for specifying a task, as the primary key, and includes the columns of job ID, allocated node ID, and state.

“Task ID” is the information for specifying a task, and is the same as “task ID” in the task management DB 223. “Job ID” is the information for specifying a job. “Allocated node ID” is the information for specifying the node (calculation server 30) that is specified by the job ID and to which the job is allocated, and is the same as “node ID” of the node management DB 222. “State” is the information indicating the state of calculation processing related to the job specified by the job ID. “Calculation result received” illustrated in FIG. 7 indicates that the calculation result for the job has been already received from the calculation server 30 to which the job has been allocated, “calculating” indicates that it is estimated that the calculation result for the job has not been received yet from the calculation server 30 to which the job has been allocated, and the calculation server 30 is performing the calculation processing related to the job, and “untransmitted” indicates that the job has not been transmitted yet to the calculation server 30 to which it has been determined to allocate the job.

In the job management DB 225, the job ID is generated by the task analysis unit 235, the task ID and the allocated node ID are stored in the job management DB 225 by a schedule generation unit 236, and the state is stored in the job management DB 225 by a job allocation unit 237.

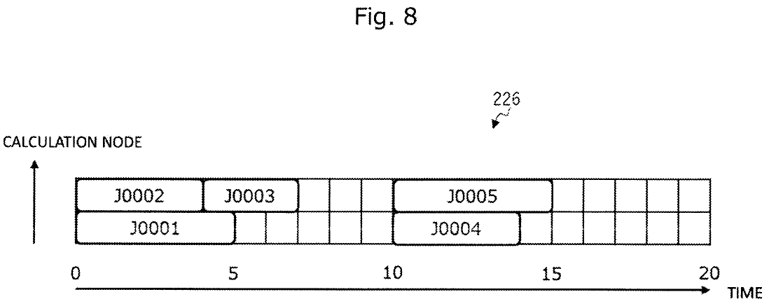

FIG. 8 is a diagram illustrating an example of the allocation table 226. The allocation table 226 is a table for allocating a task to the calculation server 30, and determining on what schedule this task is performed, and is generated by the schedule generation unit 236.

The vertical axis of the allocation table 226 represents a node (calculation server 30), and the horizontal axis represents the time (as an example, the unit is hours). It is assumed that the distributed processing system 1 in the present embodiment includes two calculation servers 30, and both the calculation servers 30 are in a state where the calculation servers 30 are participating in the distributed processing system 1. The calculation resource allocated to each of jobs is represented by a rectangle with one side representing one or more continuous calculation servers 30, and the other side representing the usage time during which those calculation servers 30 are continuously used. J0001 to J0005 are the respective names of jobs, and are written by using “job ID” in the job management DB 225. The rectangle in which the job name of each job is written represents the calculation resource required by the job. For example, the calculation resource required by the job having a job name of j0001 is 1×5.

The screen data 227 is screen data to be displayed on the terminal device 10 owned by the user, when the terminal device 10 accesses the management server 20.

The virtual drive 228 is a drive that is the same as a virtual drive 322 of the calculation server 30. More correctly, a physical storing medium forming a part of the storage unit 220 of the management server 20 and a physical storage medium forming a part of a storage unit 320 of the calculation server 30 are used to constitute the single virtual drive 228, 322. The management server 20 and the calculation server 30 perform accessing, writing, and reading of data on the virtual drive 228, 323, assuming that the common single drive 228, 322 is realized, without being aware of which server 20 or 30's physical storage medium the virtual drive 228, 323 is. Since drive virtualization technologies are well known, a detailed description is not given here.

Data constituting a task transmitted from the terminal device 10, specifically, a processing model and data written in the task definition data 224, is stored in the virtual drive 228. The calculation server 30 to which a job is allocated performs calculation processing related to the job by appropriately referring to these processing model and data. Additionally, data and the like that are required in the calculation process related to the job may also be stored in the virtual drive 228.

The destination of an IP packet that passes through the management server 20 is written in the route map 229. Since the route map 229 itself is already known, a further description is omitted here.

### <Configuration of Controller 230 of Management Server 20>

The control unit 230 of the management server 20 includes a reception control unit 231, a transmission control unit 232, a screen presentation unit 233, the node management unit 234, the task analysis unit 235, the schedule generation unit 236, the job allocation unit 237, the calculation result integration unit 238, and a privilege granting unit 239. The control unit 230 executes an application program 221 stored in the storage unit 220 to realize functional units such as these reception control unit 231 and the like.

The reception control unit 231 controls the processing in which the management server 20 receives a signal from an external device according to a communication protocol.

The transmission control unit 232 controls the processing in which the management server 20 transmits a signal to the external device according to the communication protocol.

The screen presentation unit 233 provides functions as a so-called Web server to the management server 20. Specifically, the screen presentation unit 233 generates the data of a screen (usually called a top screen) constituting a site provided by the management server 20 to the terminal device 10 accessed via the network 80, based on the data and the like stored in the screen data 227, and transmits this screen data to the accessed terminal device 10. Further, the screen presentation unit 233 dynamically (that is, interactively) changes the screen constituting the site based on an operation input from the terminal device 10, further transitions to another screen constituting the site as needed, and transmits this screen data to the terminal device 10. The details of the screens of the site presented by the screen presentation unit 233 will be described later.

The node management unit 234 updates the node management DB 222 based on the information on the calculation ability transmitted from the calculation server 30. In addition, the node management unit 234 preferably periodically measures the network distance and communication speed between the calculation server 30 and the management server 20, and updates the node management DB 222 based on the measurement result.

In addition, the node management unit 234 accepts participation indication information on whether or not to participate in the distributed processing system 1 from the calculation server 30, and updates the node management DB 222 based on this participation indication information to register the calculation server 30 that is currently participating. Additionally, in a case where the node management unit 234 receives, from a certain calculation server 30, the participation indication information that the certain calculation server 30 does not participate in (withdraw from participation in) the distributed processing system 1, when the node management unit 234 determines that a job has been transmitted to the calculation server 30 and the calculation server 30 is processing the job (actually, the determination is made based on whether or not the calculation result has not yet been received from the calculation server 30), the node management unit 234 notifies the calculation server 30 that the withdrawal of participation in the distributed processing system 1 is not permitted, causes the calculation server 30 to continue participation in the distributed processing system 1, and when the job of the calculation server 30 is completed and the calculation result is received, the node management unit 234 permits withdrawal from the participation in the distributed processing system 1. Then, the node management unit 234 writes in the node management DB 222 that the calculation server 30 is not participating in the distributed processing system 1.

The task analysis unit 235 receives the task transmitted from the terminal device 10, stores this task in the virtual drive 228, and generates the task definition data 224. Next, the task analysis unit 235 decomposes the received task into a plurality of jobs. The decomposition work from the task into jobs by the task analysis unit 235 is already known, and a further detailed description is omitted here.

When only one point is described in detail, the task analysis unit 235 analyzes the received task to estimate the man-hours of the numerical calculation processing related to this task, and decomposes the task into a plurality of jobs so that when the task is decomposed into jobs, and when numerical calculation processing is performed for each of the jobs in the calculation server 30, the man-hours become constant. Such a job decomposition step is taken for breaking down the calculation processing man-hours based on a job as much as possible, so as to accelerate withdrawal from participation in the distributed processing system 1 of the calculation server 30, since in a case where the calculation server 30 is actually performing the job when the calculation server 30 applies withdrawal from participation in the distributed processing system 1, the node management unit 234 does not immediately permit withdrawal from participation and causes the calculation server 30 to continue the processing of the job.

The schedule generation unit 236 makes a determination of allocating a job obtained by division by the task analysis unit 235 to the calculation server 30 that is participating in the distributed processing system 1 at the time, based on the calculation resource (calculation ability) of each calculation server 30 stored in the node management DB 222. Then, the schedule generation unit 236 determines a schedule of the allocated job, generates the allocation table 226 based on the determined schedule, and stores the allocation table 226 in the storage unit 220. Since the generation method of the allocation table 226 is already known, a further description is omitted here.

Here, the schedule generation unit 236 refers to the node management DB 222, and obtains the network distance between the calculation server 30 and the management server 20. Additionally, the schedule generation unit 236 refers to the node management DB 222, and calculates the routing cost between the calculation server 30 and the management server 20. Although the calculation method of the routing cost may be appropriately selected from already known methods, as an example, a technique can be listed that specifies the path on the network between the calculation server 30 and the management server 20 with reference to the route map 229, and calculates the routing cost based on the bandwidth of this path. Then, the schedule generation unit 236 determines the calculation servers 30 to which jobs are to be allocated in the order of the shortest network distance or in the order of the lowest routing cost, and determines a schedule for allocating the jobs to the determined calculation servers 30.

Additionally, when the man-hours of the numerical calculation processing of the task estimated by the task analysis unit 235 exceeds a predetermined value, the schedule generation unit 236 obtains the communication speed between the calculation server 30 and the management server 20, and determines a schedule for allocating a job to the calculation server 30 whose communication speed exceeds the predefined threshold value.

The job allocation unit 237 transmits the job obtained by division by the task analysis unit 235 to the calculation server 30 that is participating in the distributed processing system 1 at the time, based on the allocation table 226 generated by the schedule generation unit 236, and instructs the calculation processing related to the job allocated to the calculation server 30. Then, the job allocation unit 237 receives the calculation result on the job from the calculation server 30 to which the job has been transmitted. The information on the job transmission and the calculation result reception by the job allocation unit 237 is successively written in the job management DB 225 by the job allocation unit 237.

When the job allocation unit 237 receives the calculation results of all the jobs that have been allocated by the job allocation unit 237, the calculation result integration unit 238 summarizes these calculation results to generate the calculation result of the task. Then, the calculation result integration unit 238 transmits the calculation result of the generated task to the terminal device 10 that has requested the numerical calculation related to the task.

The privilege granting unit 239 grants a privilege to (an administrator of) the calculation server 30 that has transmitted the calculation result for the allocated job, based on the calculation resource (calculation ability) of the calculation server 30. There is no particular limitation to the privilege, and granting of goods, the right of using the time of the distributed processing system 1, or the like can be listed as an example.

### <Functional Configuration of Calculation Server 30>

FIG. 4 illustrates the functional configuration realized by the hardware configuration of the calculation server 30. Since the functional configuration of the calculation server 30 includes portions to common those in the functional configuration of the management server 20, a description is omitted for the common portion, and portions different from the management server 20 will be mainly described. The calculation server 30 includes the storage unit 320, a control unit 330, and a communication unit 340.

### <Configuration of Storage Unit 320 of Calculation Server 30>

The storage unit 320 of the calculation server 30 includes the virtual drive 322. The virtual drive 322 is similar to the virtual drive 228 of the management server 20.

### <Configuration of Control Unit 330 of Calculation Server 30>

The control unit 330 of the calculation server 30 includes a reception control unit 331, a transmission control unit 332, a notification unit 333, a participation notification receiving unit 334, a participation management unit 335, a calculation resource management unit 336, and a job processing unit 337. The control unit 330 executes an application program 321 stored in the storage unit 320 to realize functional units such as these reception control unit 331 and the like. The reception control unit 331 and the transmission control unit 332 has functions substantially common to those of the reception control unit 231 and the transmission control unit 232 of the management server 20.

The notification unit 333 transmits the participation indication information in the distributed processing system 1 to the management server 20, based on the setting instruction input from the owner of the calculation server 30.

The participation notification receiving unit 334 receives the determination by the management server 20 on whether or not participation in the distributed processing system 1 is possible, at least the notification from the management server 20 that withdrawal from participation in the distributed processing system 1 is not permitted, based on the participation indication information transmitted by the notification unit 333.

The participation management unit 335 identifies whether or not the calculation server 30 is participating in the distributed processing system 1 at the time, based on the participation indication information transmitted by the notification unit 333, and the determination on whether or not participation is possible received by the participation notification receiving unit 334.

The calculation resource management unit 336 identifies the calculation resource (calculation ability) of the calculation server 30, preferably periodically measures the calculation resource, and transmits the result to the management server 20.

The job processing unit 337 receives the allocated job from the management server 20, performs calculation processing related to this job, and transmits the calculation result to the management server 20.

### <Operation of Distributed Processing System 1>

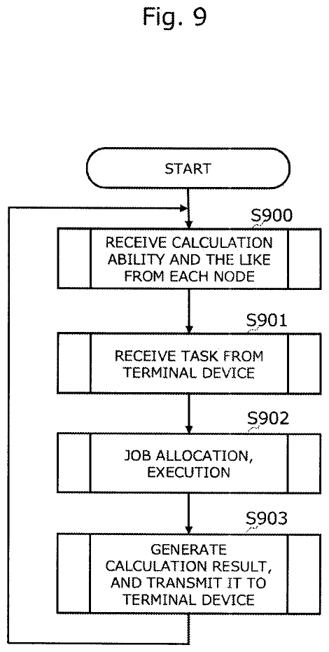

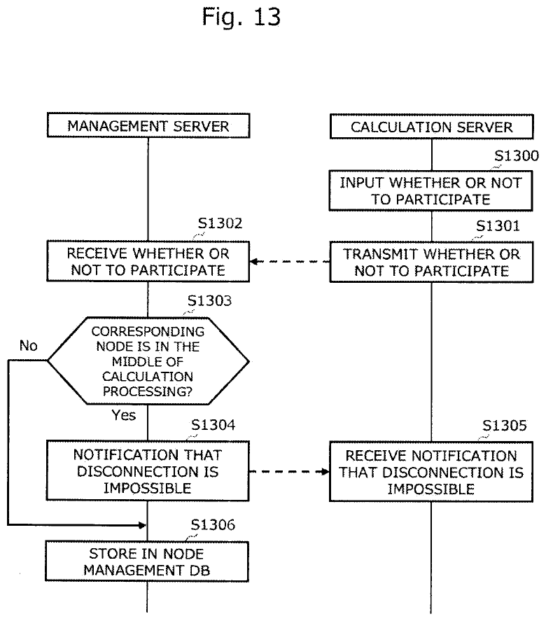

Hereinafter, referring to the flowcharts of FIG. 9 to FIG. 12 and the sequence diagram of FIG. 13, the processing in the distributed processing system 1 of the present embodiment will be described.

The flowchart indicated in FIG. 9 is a flowchart for describing the operation of the entire distributed processing system 1 of the present embodiment, focusing on the operation of the management server 20.

In FIG. 9, the management server 20 receives, from the calculation server 30 that is participating in the distributed processing system 1 (the calculation server 30 that is not participating at the time may also be included), the information on the calculation ability (calculation resource) of the calculation server 30, and the like, and updates the node management DB 222. Additionally, the management server 20 measures the network distance and communication speed between the management server 20 and each calculation server 30, and updates the node management DB 222 by using this information (S900).

Next, the management server 20 receives a task related to a calculation request from the terminal device 10 (S901).

Further, the management server 20 decomposes the task received in S901 into jobs, allocates the jobs to the calculation servers 30 that are participating in the distributed processing system 1 at that time, and transmits the allocated jobs to the calculation servers 30 (S902).

Then, the management server 20 receives the calculation results for the jobs from the calculation servers 30, generates the calculation result of the task based on the received calculation results, and transmits the calculation result of the task to the terminal device 10 that has transmitted the task (S903).

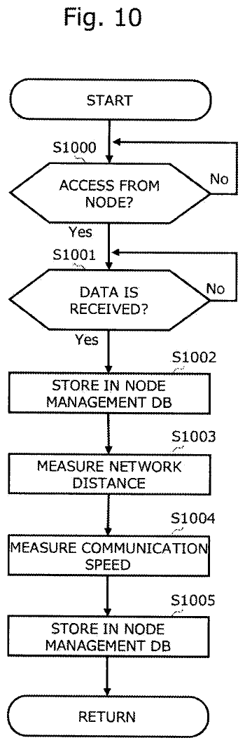

FIG. 10 is a flowchart for describing the operation of the management server 20 of the present embodiment, and is a flowchart for describing the details of the operation of S900 in FIG. 9.

First, the node management unit 234 of the management server 20 waits for access from the calculation server 30 (S1000). Then, when there is access from the calculation server 30 (YES in S1000), the node management unit 234 waits for reception of the information on the calculation ability (calculation resource) of the calculation server 30 from the calculation server 30 that has made access (S1001), and when the information is received (YES in S1001), the node management unit 234 stores the received information in the node management DB 222 to update this node management DB 222 (S1002).

Next, the node management unit 234 measures the network distance and communication speed between the calculation server 30 that is participating in the distributed processing system 1 at the time and the management server 20 (S1003, S1004), and stores the information on the measured network distance and communication speed in the node management DB 222 to update this node management DB 222 (S1005). Since the measurement technique of the network distance and communication speed has already been described, a description is omitted here.

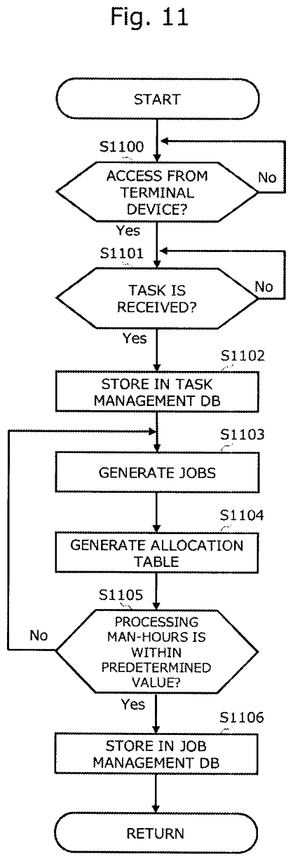

FIG. 11 is a flowchart for describing the operation of the management server 20 of the present embodiment, and is a flowchart for describing the details of the operation of S901 in FIG. 9.

First, the task analysis unit 235 of the management server 20 waits for access from the terminal device 10 (S1100). Then, when there is access from the terminal device 10 (YES in S1100), the task analysis unit 235 waits for reception of a task that is a request for calculation by the distributed processing system 1 from the terminal device 10 that has made access (S1101), and when the task is received (YES in S1101), the task analysis unit 235 stores the received information in the task management DB 223 to update this task management DB 223 (S1102).

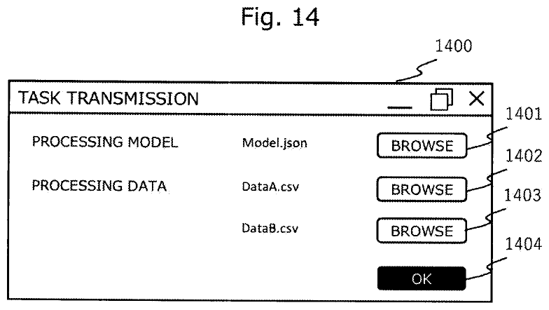

FIG. 14 illustrates an example of a screen displayed on a display, which is the output device 14 of the terminal device 10, when the terminal device 10 that requests numerical calculation processing in the distributed processing system 1 accesses the management server 20.

A screen 1400 illustrated in FIG. 14 displays a button 1401 for uploading a processing model at the time of performing numerical calculation processing to the management server 20, and buttons 1402 and 1403 for uploading processing data at the time of performing the numerical calculation processing to the management server 20. The user of the terminal device 10 specifies the processing model and processing data stored in the terminal device 10 by using the buttons 1401 to 1403, and clicks an OK button 1404 by using a touch panel or the like, which is the input device 13. When there is an input to the OK button 1404, the processor 19 of the terminal device 10 uploads the specified processing model and processing data to the management server 20.

Next, the task analysis unit 235 divides the task received in S1101 into a plurality of jobs to generate the jobs (S1103). Thereafter, the schedule generation unit 236 generates a schedule for allocating the jobs generated in S1003 to the calculation servers 30 that are participating in the distributed processing system 1 at the time, and generates the allocation table 226 based on this schedule (S1104).

Further, the task analysis unit 235 calculates the processing man-hours in the calculation server 30 based on the generated jobs, and determines whether the processing man-hours is within the predetermined value (S1105). Then, when the task analysis unit 235 determines that the processing man-hours is within the predetermined value (YES in S1105), the task analysis unit 235 updates the job management DB 225 (S1106), and when the task analysis unit 235 determines that processing man-hours exceeds the predetermined value (NO in S1105), the task analysis unit 235 returns to S1103, and generates jobs again.

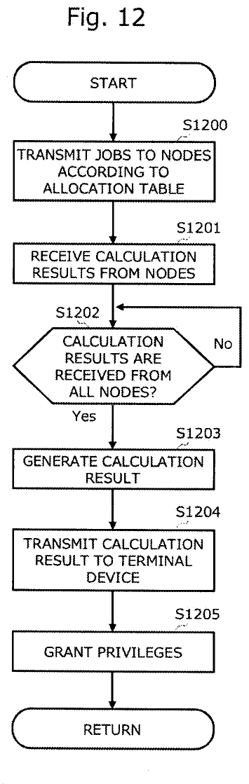

FIG. 12 is a flowchart for describing the operation of the management server 20 of the present embodiment, and is a flowchart for describing the details of the operation of S902 in FIG. 9.

First, the job allocation unit 237 transmits the allocated jobs to the calculation servers 30 that are participating in the distributed processing system 1 at the time, based on the allocation table 226 generated by the schedule generation unit 236 of S1104 in FIG. 11 (S1200).

Thereafter, the calculation result integration unit 238 receives the calculation results for the allocated jobs from the calculation servers 30 to which the jobs have been transmitted (S1201). Then, the calculation result integration unit 238 waits for reception of the calculation results from all the calculation servers 30 to which the jobs have been transmitted (S1202), and when the calculation result integration unit 238 determines that the calculation results have been received from all the calculation servers 30 (YES in S1202), the calculation result integration unit 238 generates the calculation result as the task from these calculation results of the jobs (S1203). Then, the calculation result integration unit 238 transmits the calculation result generated in S1203 to the terminal device 10 that has transmitted the task (S1204). Thereafter, the privilege granting unit 239 grants privileges to (administrators of) the calculation servers 30 that have performed the job processing (S1205).

FIG. 13 is a sequence diagram illustrating an example of the operations of the management server 20 and the calculation server 30 at the time when the calculation server 30 applies for participation registration to or withdrawal from participation in the distributed processing system 1.

First, the notification unit 333 of the calculation server 30 accepts an operation input from the administrator of the calculation server 30, thereby accepting an input as to whether or not the calculation server 30 can participate in the distributed processing system 1 (S1300).

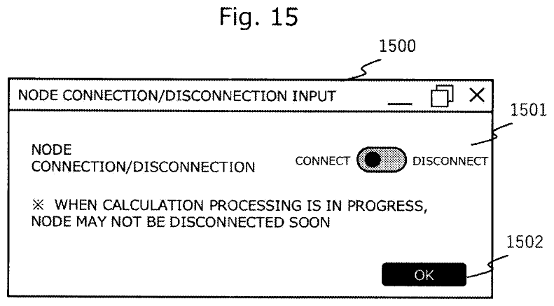

FIG. 15 is a diagram illustrating an embodiment of the screen displayed in S1300 on the display that is an example of an output device, an illustration of which is omitted, provided in the calculation server 30. A screen 1500 illustrated in FIG. 15 displays a button 1501 for instructing whether to connect the calculation server (node) 30 to the management server 20, in other words, to cause the calculation server 30 to participate in the distributed processing system 1, or to disconnect the calculation server 30 from the management server 20, in other words, to cause the calculation server 30 to withdraw from participation in the distributed processing system 1. The administrator of the calculation server 30 performs a slide operation of this button 1501 by using a mouse or the like, which is the input device, an illustration of which is omitted, provided in the calculation server 30, and further performs clicking or the like on an OK button 1502 to perform an instruction to transmit the participation indication information to the management server 20.

Returning to FIG. 13, the notification unit 333 of the calculation server 30 transmits the participation indication information to the management server 20, based on the instruction from the administrator of the calculation server 30 (S1301). The node management unit 234 of the management server 20 receives the participation indication information from the calculation server 30 (S1302), and determines whether or not the calculation server 30 that has transmitted the participation indication information is in the middle of the calculation processing at the time (S1303). Then, when the node management unit 234 determines that the calculation server 30 that has transmitted the participation indication information is in the middle of the calculation processing at the time (YES in S1303), the node management unit 234 notifies the calculation server 30 that has transmitted the participation indication information that disconnection of (withdrawal from participation in) the participation in the distributed processing system 1 is impossible (S1304), and the participation notification receiving unit 334 of the calculation server 30 receives this notification (S1305).

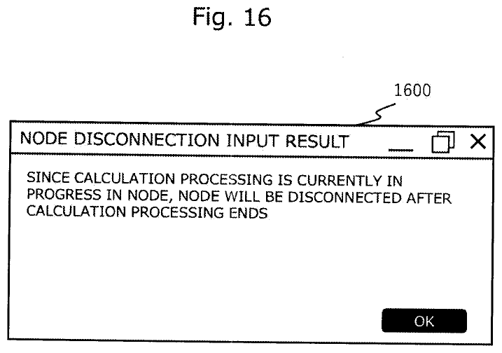

FIG. 16 is a diagram illustrating an example of the screen displayed on the display that is the output device 14 of the calculation server 30, according to the notification based on S1304. A screen 1600 illustrated in FIG. 16 displays that, although the participation in the distributed processing system 1 is continued, withdrawal from participation in the distributed processing system 1 will be performed when the calculation processing related to a job ends.

Returning to FIG. 13, the node management unit 234 updates the node management DB 222 based on the participation indication information transmitted from the calculation server 30, and the notification in S1304 that withdrawal from participation is impossible (S1306).

### <Effects of Embodiment>

As described above in detail, according to the distributed processing system 1 of the present embodiment, it becomes possible to realize a virtual data center (DC), and to provide a user with distributed processing that effectively utilizes calculation resources quickly and at low cost.

Additionally, when the calculation processing man-hours of a task exceeds the predetermined value, the distributed processing system 1 of the present embodiment obtains the communication speed between the calculation servers 30 and the management server 20, and generates a schedule for allocating jobs to the calculation servers 30 for which the communication speeds exceed the predefined threshold value. That is, stable and low-cost calculation processing can be performed by allocating the jobs to the calculation servers 30 for which the communication speed is high, and as a result, the communication between the management server 20 and the calculation servers 30 is stable (in this case, it is sufficiently estimated that the network distances between the management server 20 and the calculation servers 30 are short).

Additionally, in the distributed processing system 1 of the present embodiment, since the distributed processing system 1 is built by the calculation servers 30 that are participating in the distributed processing system 1 at the time, based on the participation indication information transmitted from the calculation servers 30, the administrators of the calculation servers 30 can participate in the distributed processing system 1 only when the administrators desires to provide the calculation resources of the calculation servers 30 to the distributed processing system 1. Accordingly, it is possible to realize a mode in which, normally, the administrator of the calculation server 30 is using the calculation server 30 for performing the administrator's own calculation processing, and its free time (in other words, a free resource) is provided to the distributed processing system 1. Such a mode leads to expanding the number and range of the calculation servers 30 that participate in the distributed processing system 1, and as a result, it becomes possible to provide users with the distributed processing that effectively utilizes the calculation resources in the city.

At this time, when the calculation server 30 that has transmitted the participation indication information is performing the calculation processing of a job at that time (the administrator of the calculation server 30 will not directly know whether or not the calculation processing of the job is being performed), the calculation server 30 cannot withdraw from participation in the distributed processing system 1, until the calculation processing ends and the calculation result is transmitted to the management server 20. Accordingly, it is possible to prevent the calculation server 30 from withdrawing from participation in the distributed processing system 1 at unexpected timing.

However, when the time after the calculation server 30 transmits the participation indication information until the calculation server 30 can actually withdraw from participation in the distributed processing system 1 becomes long, this can also cause the administrator of the calculation server 30 to wait for a long time. Therefore, the management server 20 breaks down jobs so that the calculation processing man-hours based on each of the jobs becomes constant, and accordingly, the calculation server 30 that has transmitted the participation indication information can withdraw from the distributed processing system 1 as early as possible. On the other hand, considering the distributed processing system 1 as a whole, even if the calculation server 30 withdraws from the distributed processing system 1, by breaking down jobs, a job that has been originally allocated to the calculation server 30 that has withdrawn from participation can be quickly allocated to another calculation server 30, and the processing time loss for the entire distributed processing system 1 can be suppressed.

Further, the distributed processing system 1 of the present embodiment determines the calculation servers 30 to which jobs are to be allocated in the order of the closest network distance between the management server 20 and the calculation server 30 or in the order of the lowest routing cost, and determines a schedule for allocating the jobs to the determined calculation servers 30. Accordingly, it is possible to reduce the burden of the network and calculation processing as the entire distributed processing system 1.

### <Supplement>

Note that, in the above-described embodiment, the configurations have been described in detail for describing the present disclosure in an easy-to-understand manner, and the present disclosure is not necessarily limited to the embodiment including all the described configurations. Additionally, it is possible to add, delete, and replace a part of the configuration of each embodiment with another configuration.

As an example, in the above-described embodiment, although the distributed processing system 1 consisting of the management server 20 and the (plurality of) calculation servers 30 has been described, a higher management server may be provided that supervises the management server 20. That is, the management server 20 and the calculation servers 30 constitute the single distributed processing system 1, a plurality of such distributed processing systems 1 may be provided, and the higher management server for supervising the plurality of distributed processing systems 1 may supervise the plurality of distributed processing systems 1. In this case, it is possible to consider the distributed processing system supervised by the higher management server as one distributed processing system, and to consider that, under this distributed processing system, a plurality of lower distributed processing systems exist. The higher management server manages the resources of the distributed processing systems 1 that exists under the higher management server. In such a configuration, when connection between the higher management server and a management server is lost, the management server can also share at least a part of the administrative work of the higher rank management server.

Additionally, a part or all of each of the above-described configurations, functions, processing units, processing means, and the like may be realized in hardware by designing them with, for example, integrated circuits. Additionally, the present invention can also be realized in a program code of software that realizes the functions of the present embodiment. In this case, a storage medium recording the program code is provided to a computer, and a processor included in the computer reads the program code stored in the storage medium. In this case, the program code itself read from the storage medium will realize the functions of the present embodiment, and the program code itself and the storage medium storing the program code will constitute the present invention. As a storage medium for supplying such a program code, for example, a flexible disk, a CD-ROM, a DVD-ROM, a hard disk, an SSD, an optical disc, a magneto-optical disc, a CD-R, a magnetic tape, a nonvolatile memory card, a ROM, or the like is used.

Additionally, the program code that realizes the functions described in the present embodiment can be implemented in a wide range of programing languages or script languages, such as an assembler, C/C++, Perl, Shell, PHP, and Java (registered trademark).

Further, the program code of the software that realizes the functions of the present embodiment may be distributed via a network, it may be stored in storing means such as a hard disk and a memory of a computer, or in a storage medium such as a CD-RW and a CD-R, and a processor included in a computer may read and execute the program code stored in the storing means or the storage medium.

The matters described in each embodiment described above will be supplemented below.

### (Supplement 1)

A program (221) for operating a management server (2, 20) in a distributed processing system (1) that includes a plurality of nodes (3, 30), and the management server (2, 20) connected to each of the nodes (3, 30) via a network (5, 80), each of the nodes (3, 30) performing participation in the distributed processing system (1) via the network (5, 80) according to its own setting, wherein the management server (2, 20) includes a processor (29) and a memory (25), and the program (221) causes the processor (29) to execute a first step (S901) of accepting, by the entire distributed processing system (1), a task that is a request for calculation by the distributed processing system (1) from a client (4, 10) outside the distributed processing system (1), a second step (S902) of decomposing the task into a plurality of jobs, a third step (S902) of determining, from calculation resources available for the nodes (3, 30) obtained in advance from the nodes (3, 30), respectively, a schedule of the jobs to be allocated to the nodes (3, 30), a fourth step (S902) of transmitting, based on the schedule, the jobs to be allocated to the nodes (3, 30), respectively, a fifth step (S903) of accepting calculation results of the jobs from the nodes (3, 30), respectively, a sixth step (S903) of generating a calculation result of the task based on the accepted calculation results of the jobs, and a seventh step (S903) of transmitting the calculation result of the task to the client (4, 10).

### (Supplement 2)

The program (221) according to supplement 1, wherein the program (221) calculates a calculation processing man-hours of the task in the third the step (S902), and when the calculation processing man-hours exceeds a predetermined value, the program (221) obtains communication speed between the nodes (3, 30) and the management server (2, 20), and generates the schedule that allocates the jobs to the nodes (3, 30) for which the communication speed exceeds a predefined threshold value.

### (Supplement 3)

The program (221) according to supplement 1, wherein the program (221) further cause the processor to execute an eighth step (S1302) of accepting, from each of the nodes (3, 30), participation indication information on whether or not to participate in the distributed processing system (1), and a ninth step (S1306) of registering the nodes (3, 30) that are participating at the time, based on the participation indication information, and in the third the step (S902), the program (221) further determines the schedule of the jobs to be allocated to the nodes (3, 30) that are participating at the time.

### (Supplement 4)

The program (221) according to supplement 3, wherein, in the eighth step (S1302), the program (221) accepts the participation indication information and calculation resource information on the calculation resource.

### (Supplement 5)

The program (221) according to supplement 3, wherein the program (221) further causes the processor to execute a tenth step (S1304) of determining whether or not each of the nodes (3, 30) is capable of participating in the distributed processing system (1), based on the participation indication information, and in the tenth step (S1304), when the program (221) accepts, from the nodes (3, 30) to which the jobs are allocated and from which the calculation results are not accepted, the participation indication information that the nodes (3, 30) do not participate in the distributed processing system (1), the program (221) determines to cause the nodes (3, 30) to continue participation in the distributed processing system (1) until the calculation results of the jobs are accepted.

### (Supplement 6)

The program (221) according to supplement 5, wherein, in the second step (S902), the program (221) decomposes the task into a plurality of the jobs so that calculation processing man-hours based on each of the jobs becomes constant.

### (Supplement 7)

The program (221) according to supplement 1, wherein the program (221) further causes the processor to execute an eleventh step (S1205) of granting privileges based on the calculation resources to the nodes (3, 30) from which the calculation results of the jobs have been accepted.

### (Supplement 8)

The program (221) according to supplement 1, wherein, in the third step (S902), the program (221) obtains a network distance between each of the nodes (3, 30) and the management server (2, 20), determines the nodes (3, 30) to which the jobs are to be allocated in an order of shortest network distance, and determines the schedule for allocating the jobs to the determined nodes (3, 30).

### (Supplement 9)

The program (221) according to supplement 8, wherein, in the third step (S902), the program (221) obtains a routing cost between each of the nodes (3, 30) and the management server (2, 20), determines the nodes (3, 30) to which the jobs are to be allocated in the order of shortest network distance or in an order of lowest routing cost, and determines the schedule for allocating the jobs to the determined nodes (3, 30).

### (Supplement 10)

A management server (2, 20) in a distributed processing system (1) that includes a plurality of nodes (3, 30), and the management server (2, 20) connected to each of the nodes (3, 30) via a network, each of the nodes (3, 30) performing participation in the distributed processing system (1) via the network (5, 80) according to its own setting, wherein the management server (2, 20) comprises a processor (29) and a memory (25), and the processor (29) executes a first step (S901) of accepting, by the entire distributed processing system (1), a task related to a request for calculation from a client (4, 10) outside the distributed processing system (1), a second step (S902) of decomposing the task into a plurality of jobs, a third step (S902) of determining, from calculation resources available for the nodes (3, 30) obtained in advance from the nodes (3, 30), respectively, a schedule of the jobs to be allocated to the nodes (3, 30), a fourth step (S902) of transmitting, based on the schedule, the jobs to be allocated to the nodes (3, 30), respectively, a fifth step (S903) of accepting calculation results of the jobs from the nodes (3, 30), respectively, a sixth step (S903) of generating a calculation result of the task based on the accepted calculation results of the jobs, and a seventh step (S903) of transmitting the calculation result of the task to the client (4, 10).

### (Supplement 11)

A distributed processing system (1) including a plurality of nodes (3, 30), and a management server (2, 20) connected to each of the nodes (3, 30) via a network, each of the nodes (3, 30) performing participation in the distributed processing system (1) via the network according to its own setting, wherein the management server (2, 20) comprises a processor (29) and a memory (25), and the processor (29) executes a first step (S901) of accepting, by the entire distributed processing system (1), a task related to a request for calculation from a client (4, 10) outside the distributed processing system (1), a second step (S902) of decomposing the task into a plurality of jobs, a third step (S902) of determining, from calculation resources available for the nodes (3, 30) obtained in advance from the nodes (3, 30), respectively, a schedule of the jobs to be allocated to the nodes (3, 30), a fourth step (S902) of transmitting, based on the schedule, the jobs to be allocated to the nodes (3, 30), respectively, a fifth step (S903) of accepting calculation results of the jobs from the nodes (3, 30), respectively, a sixth step (S903) of generating a calculation result of the task based on the accepted calculation results of the jobs, and a seventh step (S903) of transmitting the calculation result of the task to the client (4, 10).

### (Supplement 12)

A method to be executed by a management server (2, 20) in a distributed processing system (1) that includes a plurality of nodes (3, 30), and the management server (2, 20) connected to each of the nodes (3, 30) via a network (5, 80), each of the nodes (3, 30) performing participation in the distributed processing system (1) via the network (5, 80) according to its own setting, wherein the management server (2, 20) comprises a processor (29) and a memory (25), and the processor (29) executes a first step (S901) of accepting, by the entire distributed processing system (1), a task related to a request for calculation from a client (4, 10) outside the distributed processing system (1), a second step (S902) of decomposing the task into a plurality of jobs, a third step (S902) of determining, from calculation resources available for the nodes (3, 30) obtained in advance from the nodes (3, 30), respectively, a schedule of the jobs to be allocated to the nodes (3, 30), a fourth step (S902) of transmitting, based on the schedule, the jobs to be allocated to the nodes (3, 30), respectively, a fifth step (S903) of accepting calculation results of the jobs from the nodes (3, (30), respectively, a sixth step (S903) of generating a calculation result of the task based on the accepted calculation results of the jobs, and a seventh step (S903) of transmitting the calculation result of the task to the client (4, 10).

What is claimed is:

1. An apparatus in a distributed processing system that includes a plurality of nodes, and the management server connected to each of the nodes via a network, each of the nodes performing participation in the distributed processing system via the network according to its own setting, comprising:
processing circuitry configured to:
accept, by the entire distributed processing system, a task that is a request for calculation by the distributed processing system from a client outside the distributed processing system;
decompose the task into a plurality of jobs;
determine, from calculation resources available for the nodes obtained in advance from the nodes, respectively, a schedule of the jobs to be allocated to the nodes;
transmit, based on the schedule, the jobs to be allocated to the nodes, respectively;
accept calculation results of the jobs from the nodes, respectively;
generate a calculation result of the task based on the accepted calculation results of the jobs; and
transmit the calculation result of the task to the client.

2. The apparatus according to claim 1,
wherein in determining the schedule, calculate a calculation processing man-hours of the task, and when the calculation processing man-hours exceeds a predetermined value, obtain communication speed between the nodes and the management server, and generate the schedule that allocates the jobs to the nodes for which the communication speed exceeds a predefined threshold value.

3. The apparatus according to claim 1,
the processing circuitry further configured to:
accept, from each of the nodes, participation indication information on whether or not to participate in the distributed processing system; and
register the nodes that are participating at the time, based on the participation indication information, and
in determining the schedule, determine the schedule of the jobs to be allocated to the nodes that are participating at the time.

4. The apparatus according to claim 3,
wherein, in accepting the participation indication information, accept the participation indication information and calculation resource information on the calculation resource.

5. The apparatus according to claim 3,
the processing circuitry further configured to:
determine whether or not each of the nodes is capable of participating in the distributed processing system, based on the participation indication information, and
in determining whether or not each of the nodes is capable of participating in the distributed processing system, when the processing circuitry accept, from the nodes to which the jobs are allocated and from which the calculation results are not accepted, the participation indication information that the nodes do not participate in the distributed processing system, determine to cause the nodes to continue participation in the distributed processing system until the calculation results of the jobs are accepted.

6. The apparatus according to claim 5,
wherein, in decomposing the task, decompose the task into a plurality of the jobs so that calculation processing man-hours based on each of the jobs becomes constant.

7. The apparatus according to claim 1,
the processing circuitry further configured to:
grant privileges based on the calculation resources to the nodes from which the calculation results of the jobs have been accepted.

8. The apparatus according to claim 1,
wherein, in determining the schedule, obtain a network distance between each of the nodes and the management server, determine the nodes to which the jobs are to be allocated in an order of shortest network distance, and determine the schedule for allocating the jobs to the determined nodes.

9. The apparatus according to claim 8,
wherein, in determining the schedule, obtain a routing cost between each of the nodes and the management server, determine the nodes to which the jobs are to be allocated in the order of shortest network distance or in an order of lowest routing cost, and determine the schedule for allocating the jobs to the determined nodes.

10. A management server in a distributed processing system that includes a plurality of nodes, and the management server connected to each of the nodes via a network, each of the nodes performing participation in the distributed processing system via the network according to its own setting, comprising:
processing circuitry configured to:
accept, by the entire distributed processing system, a task related to a request for calculation from a client outside the distributed processing system;
decompose the task into a plurality of jobs;
determine, from calculation resources available for the nodes obtained in advance from the nodes, respectively, a schedule of the jobs to be allocated to the nodes;
transmit, based on the schedule, the jobs to be allocated to the nodes, respectively;
accept calculation results of the jobs from the nodes, respectively;
generate a calculation result of the task based on the accepted calculation results of the jobs; and
transmit the calculation result of the task to the client.

11. A distributed processing system including a plurality of nodes, and a management server connected to each of the nodes via a network, each of the nodes performing participation in the distributed processing system via the network according to its own setting,
wherein the management server comprises processing circuitry configured to:
accept, by the entire distributed processing system, a task related to a request for calculation from a client outside the distributed processing system;
decompose the task into a plurality of jobs;
determine, from calculation resources available for the nodes obtained in advance from the nodes, respectively, a schedule of the jobs to be allocated to the nodes;
transmit, based on the schedule, the jobs to be allocated to the nodes, respectively;
accept calculation results of the jobs from the nodes, respectively;
generate a calculation result of the task based on the accepted calculation results of the jobs; and
transmit the calculation result of the task to the client.

12. A method to be executed by a management server in a distributed processing system that includes a plurality of nodes, and the management server connected to each of the nodes via a network, each of the nodes performing participation in the distributed processing system via the network according to its own setting,
wherein the management server comprises a processor and a memory, and
the processor executes:
a first step of accepting, by the entire distributed processing system, a task related to a request for calculation from a client outside the distributed processing system;
a second step of decomposing the task into a plurality of jobs;
a third step of determining, from calculation resources available for the nodes obtained in advance from the nodes, respectively, a schedule of the jobs to be allocated to the nodes;
a fourth step of transmitting, based on the schedule, the jobs to be allocated to the nodes, respectively;
a fifth step of accepting calculation results of the jobs from the nodes, respectively;
a sixth step of generating a calculation result of the task based on the accepted calculation results of the jobs; and
a seventh step of transmitting the calculation result of the task to the client.
